(19) United States
(12) Patent Application Publication
(10) Pub. No.: US 2019/0129593 A1
(43) Pub. Date: May 2, 2019

(54) METHOD AND SYSTEM FOR MANAGING A PARCEL IN A VIRTUAL ENVIRONMENT

(71) Applicant: PARCELL LLC, Castro Valley, CA (US)

(72) Inventors: Michael Chein, Castro Valley, CA (US); Yotam Margalit, Castro Valley, CA (US); David F. Crosby, Castro Valley, CA (US)

(73) Assignee: PARCELL LLC, Castro Valley, CA (US)

(21) Appl. No.: 16/083,383

(22) PCT Filed: Mar. 10, 2017
(86) PCT No.: PCT/US17/21796

§ 371 Date: Sep. 7, 2018

Related U.S. Application Data
(60) Provisional application No. 62/306,853, filed on Mar. 11, 2016.
(60) Provisional application No. 62/455,864, filed on Feb. 7, 2017.

(51) Int. Cl. G06F 3/0484; G06F 16/955; G06F 16/29; G06Q 10/08; G06Q 30/02; G06F 3/0482

(52) U.S. Cl. CPC G06F 3/0484; G06F 16/9566; G06F 16/29; H04L 67/10; G06Q 10/083; G06Q 30/0239; G06F 3/0482; G06F 16/9554

(57) ABSTRACT

An interactive system includes a database for storing information including an identification and a location of a parcel, a server connected to the database for accessing information about parcels stored in the database and one or more user devices connected to the server over a network such as the internet. The interactive system can present to the user of the user device a virtual world that includes one or more parcels. Each parcel can be associated with one or more elements of content (e.g., text, audio and or video) and/or a coupon enabling the user to purchase a real object or thing (e.g., a cup of coffee, dinner at a restaurant, theater tickets, etc.). The parcel can include a plurality of attributes that device how each user can interact with the parcel, for example whether a user can take possession of the parcel and view its content or redeem the coupon.

### CROSS-REFERENCE TO RELATED APPLICATIONS

This application claims any and all benefits as provided by law including benefit under 35 U.S.C. § 119(e) to U.S. Provisional Application No. 62/306,853 filed Mar. 11, 2016 and U.S. Provisional Application No. 62/455,864 filed Feb. 7, 2017, both of which are hereby incorporated by reference in their entirety.

### STATEMENT REGARDING FEDERALLY SPONSORED RESEARCH

Not Applicable.

### REFERENCE TO MICROFICHE APPENDIX

Not Applicable

### BACKGROUND

### Technical Field of the Invention

The present invention relates to a virtual reality based social networking platform in which users can interact with geotagged digital parcels. A parcel can represent any form of content as well as an interest in any physical article. A user can pick up parcels and drop off parcels at different locations to gain points and/or view their content. Users also create custom designed parcels for other users to view, edit, pickup and drop off.

### Description of the Prior Art

Virtual reality (and augmented reality) systems enable users to interact with virtual reality environments and augmented reality environments. These systems are used, for example, to provide computer and/or electronic gaming environments. In some virtual reality environments, the user interacts with a world or environment that is fictitious. Thus, some or all of the elements (e.g., the geography, maps, buildings and other structures) that are presented in the virtual environment may not exist in the real world, but exist as a virtual object in the virtual reality system. In some virtual reality systems, sometimes referred to as augmented reality systems, at least some portions of the virtual world (e.g., the geography, maps, buildings and other structures) can be the same as or similar to those in the real world, representing those objects as they exist in the real world. In augmented reality environments, at least some of the objects in the virtual environment are real and virtual objects can be overlaid or mixed with the real objects. Virtual reality systems manage the users' interaction with the virtual objects in the virtual world and manage the users' interaction with real and virtual objects in a world that can include both real and virtual elements or objects. The virtual reality system maintains a digital representation of the virtual world (and, in some embodiments that can include portions that match or are similar to the real world) and tracks the location and movements of real and virtual objects and users in the virtual world.

### SUMMARY

The present invention is directed to a method and system for managing parcels in virtual reality systems (which include augmented reality systems). In accordance with some embodiments of the invention, the system can include a server connected to a network (such as the Internet). Users can interact with real and virtual objects in the virtual world (which can include portions that correspond to the real world) using a user device, that is connected to the network, by communicating with the server to send and receive data about the user's location and the objects associated with the user's location. The system further includes one or more databases that can be connected to the server and that store information about each user, each user device and each object in the virtual or real world, and transmits information about users and objects to the user device to enable the user to interact with objects and other users in the virtual reality system.

In accordance with the invention, the user device can include a positioning system (e.g., a GPS) that enables the user device to determine its location relative to a 2 or 3 dimensional space, such as the a map or a spatial database. The user device can include a software module (e.g., an app or program) that enables the user device to communicate with the server and transfer data between the server and the user device. The software module can interact with the positioning system to receive location data and use the location data to position the user device in and relative other users and objects in a virtual environment. The virtual environment can include a real world map or geographical location database, a virtual (e.g., fictitious) map or geographical location database or an environment that includes both, a real world map and geographical location database and a virtual (e.g., fictitious) map or geographical location database. The user device can send its location data to the server which interacts with one or more databases to store the user location data and process the user device location and other user or user device attributes to identify parcels within range (e.g., in the same location or within a predefined distance from the user device location). The server can send to the user device information about one or more parcels that are in range of the user device and cause the software module in the user device to notify and/or interact with the user. In some embodiments of the invention, the user device, upon receiving information about one or more parcels in range of the user device, can cause a device connected to the user device to notify or interact with the user. The user can, upon receiving notification from the user device, interact with the touch screen or other input device associated with the user device to explore, interact with and take virtual possession of a parcel.

A parcel can be a virtual object in the virtual environment having attributes stored in one or more of the databases of the virtual reality system. In accordance with some embodiments of the invention, a parcel can be given any attributes that a real world object can have. In accordance with some embodiments of the invention, a parcel can be given fictitious or imaginary attributes that represent attributes that a real object cannot have (e.g., time travel, weightlessness, perpetual motion). In accordance with some embodiments, the attributes of a parcel can include a geographic location in the virtual world (and/or the real world) and content (e.g., text, audio, and/or video) that the user can view/listen to. The content can include an advertisement for a product and/or service and can be redeemable for a product or service (e.g., a cup of coffee, a ride to the airport, 10% discount on the purchase of a product). In accordance with some embodiments of the invention, other attributes of a parcel stored in the database include the identity of the owner, whether the parcel ownership is transferrable and the nature or degree to which the owner is transferrable (e.g., rented as compared to purchased) and the time duration of the transferred ownership interest. The database can also store historical information about past locations of parcel as well as past owners and possessors of the parcel. In accordance with some embodiments of the invention, any user can drop a parcel at any location and define the attributes of the parcel to enable another user to take possession and/or own the parcel, as well as define the conditions under which the other user can take possession and/or ownership of the parcel. For example, the user can specify how close the user device needs to be to the parcel to interact with (e.g., view, see its features or attributes) the parcel, take possession (or other degree of ownership) of the parcel, how old the user needs to be to take possession (or ownership) of the parcel, and/or any other conditions and/or attributes of the user or the user device in order to take possession (or ownership) of the parcel.

In accordance with implementations of the invention, one or more of the following capabilities may be provided.

The methods and systems according to some embodiments of the invention enable one or more users or operators to implement a virtual scavenger hunt in which users can move in a virtual and/or real world in search of parcels.

The methods and systems according to some embodiments of the invention enable one or more users or operators to implement a virtual advertising environment in which users can move in a virtual and/or real world in search of parcels intended for specific users including potential customers or consumers.

These and other capabilities of the invention, along with the invention itself, will be more fully understood after a review of the following figures, detailed description, and claims.

### BRIEF DESCRIPTION OF THE FIGURES

The accompanying drawings, which are incorporated into this specification, illustrate one or more exemplary embodiments of the inventions and, together with the detailed description, serve to explain the principles and applications of these inventions. The drawings and detailed description are illustrative, and are intended to facilitate an understanding of the inventions and their application without limiting the scope of the invention. The illustrative embodiments can be modified and adapted without departing from the spirit and scope of the inventions.

FIG. 1 is a diagrammatic view of an interactive system according to some embodiments of the invention.

FIGS. 2A and 2B show diagrammatic views of a user device and a system display according to some embodiments of the invention.

FIG. 3 shows a flow chart of a method according to some embodiments of the invention.

### DETAILED DESCRIPTION OF PREFERRED EMBODIMENTS

The present invention is directed to an interactive system such as a gaming system, a virtual reality system and/or an augmented reality system that stores information about users and parcels and manages the interaction of user devices with other user devices and parcels that are part of the system. The system manages these interactions over a network of centralized or distributed servers that store and process information about the user devices and the parcels. Parcels can represent virtual objects and/or real objects as well as provide rights to real objects.

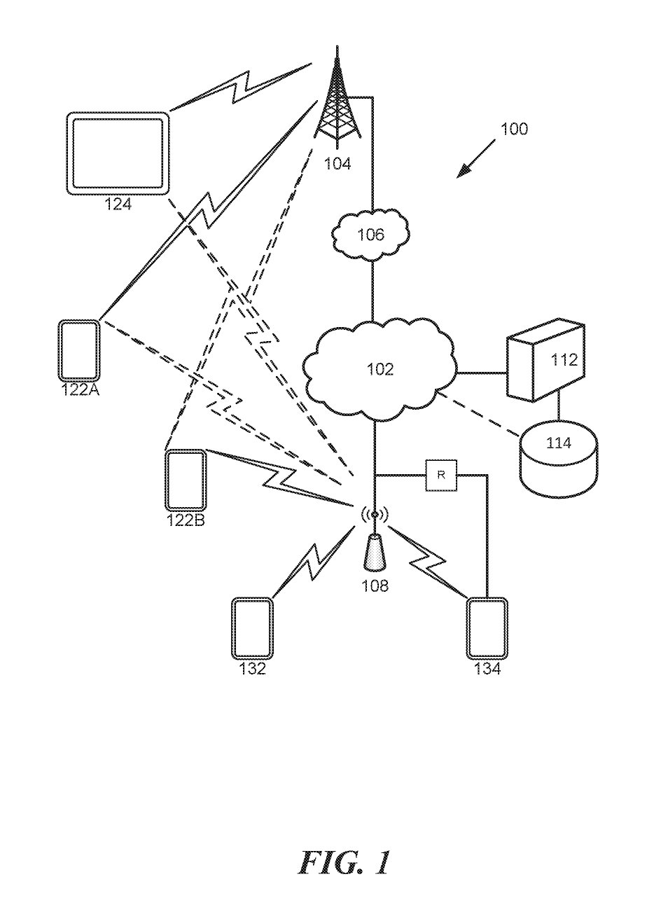

FIG. 1 shows a diagram of a system 100 according to some embodiments of the invention. In accordance with some embodiments, the system 100 can include a plurality of portable or mobile user devices 122A, 122B, 124, 132, connected by a network 102 (e.g., a public network such as the Internet or private network) to one or more servers 112 and databases 114. In accordance with some embodiments, one or more of the user devices 134 can be stationary or fixed in their physical location. The mobile devices 122A, 122B, 124, 132 can be connected to the network 102 by a wireless connection, such as a mobile data service via a mobile data antenna 104 and a carrier data network 106 or a WiFi connection via a WiFi access point 108. The stationary user devices 134 can be connected to the network 102 by a wireless connection, 106 or 108, or a wired connection (e.g., an Ethernet connection).

Each of the mobile user devices can include a computer (e.g., one or more processors and associated memory to execute one or more programs or program modules and interact with peripheral systems including a network interface or communication module for connecting the user device to the network) and a positioning system for determining the location of the user device (or a user avatar) in a virtual environment (which can include, at least a portion of the real world). In accordance with some embodiments, the positioning system can include a Global Positioning System (GPS) module (e.g., a combination of hardware and software) that determines data about the location of the user device relative to real earth geography. In accordance with some embodiments, the positioning system can transfer location data to a software module that tracks the movements of the user device (e.g., based on user device movement in the real world and/or user inputs from a user input device such as a game controller, a mouse or a keyboard) on a real or virtual map (or a position database). The positioning system can also use wireless telemetry to determine a location of a user device, for example, based on wireless signal strength and/or network address location services (e.g., IP-based Geolocation). The user device can include a display screen that shows the location of the user device and the parcels in the virtual environment (e.g., a map of the real world and/or a virtual world). The display screen can be touch sensitive or the user device can include a mouse point that enables the user to interact with the images and text presented on the display screen by the software modules to select and cause software modules in the user device to execute or change their operation. Each mobile device can include on or more software modules that display a map of the virtual environment to user, enabling the user to zoom in to view more detail of the virtual environment, and zoom out to view a larger area and potentially more remotely located parcels. Each mobile user device can further include one or more software modules (e.g., apps or program modules) that enable the user device to communicate with the server 112 and the database 114 over the network 102.

The server 112 can include a conventional webserver configured to communicate with the user device using well known data communication protocols (e.g., HTTP, HTTPS, TCP/IP) or using proprietary communication protocols. In accordance with some embodiments of the invention, the server 112 can be connected to one or more databases 114 directly and/or over the network 102 (as represented by the dashed line). In accordance with some embodiments of the invention, the server 112 can be connected to a remote user database that stores information relating to users, user accounts and connected directly to a parcel database and a virtual environment database (e.g., information about the real and/or virtual map and other objects and structures in the virtual environment). The server 112 can also include one or more software modules (e.g., applications) that execute on one or more servers 112 to process the data requests from user devices and implement the rules of the interactive system that control what data is sent to user devices. The databases can be constructed using any data storage format including relational databases (e.g., SQL based), non-relational databases, not only SQL databases, or flat data files. The database associates elements of information with each other, for example, the database associates a user name or user ID with one or more attributes of the user having the associate user name or user ID and enables the server to find one or more attributes of the user. For example, searching the database for a user name or use ID returns to the server one or more or all attributes associated in the database with that name or user ID. For example, searching the database for a parcel name or parcel ID returns to the server one or more or all the attributes associated in the database with the parcel name or parcel ID. For example, searching the database for a location returns to the server the user name or user ID and/or the parcel name or parcel ID of the users and/or parcels at that location. In the case of location searching, the search can include range or tolerance that returns names and IDs associated with users or parcels that are within the range or tolerance. In accordance with some embodiments of the invention, a single common database can be used store the data relating to users, objects, parcels, maps, the virtual world and other information relating to the interactive system. In accordance with some embodiments, at least some of the data relating to the users, objects, parcels, maps, the virtual world environment and other information relating to the interactive system can be stored in separate databases.

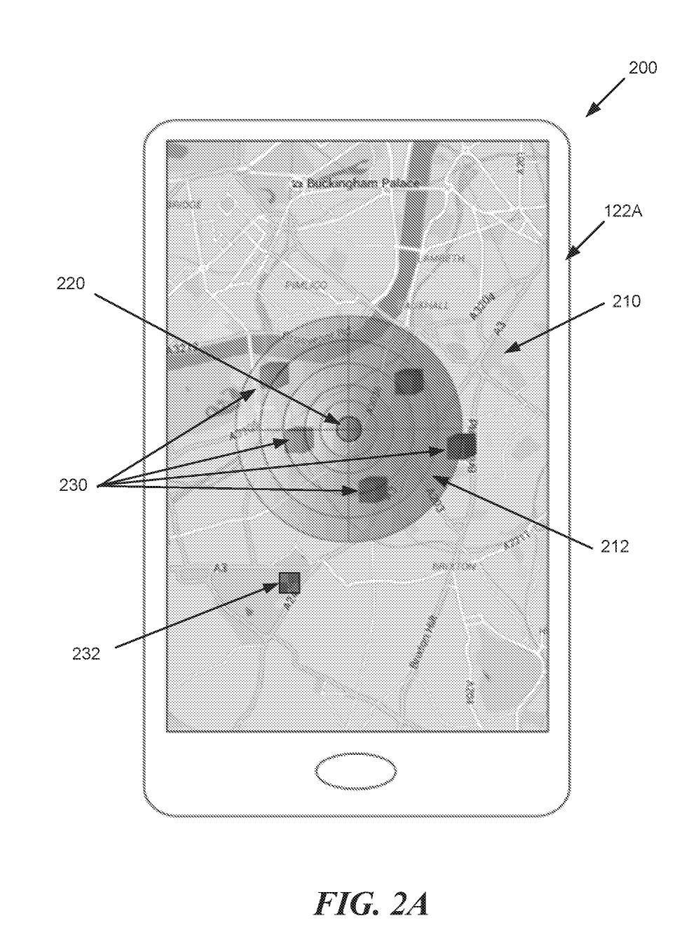

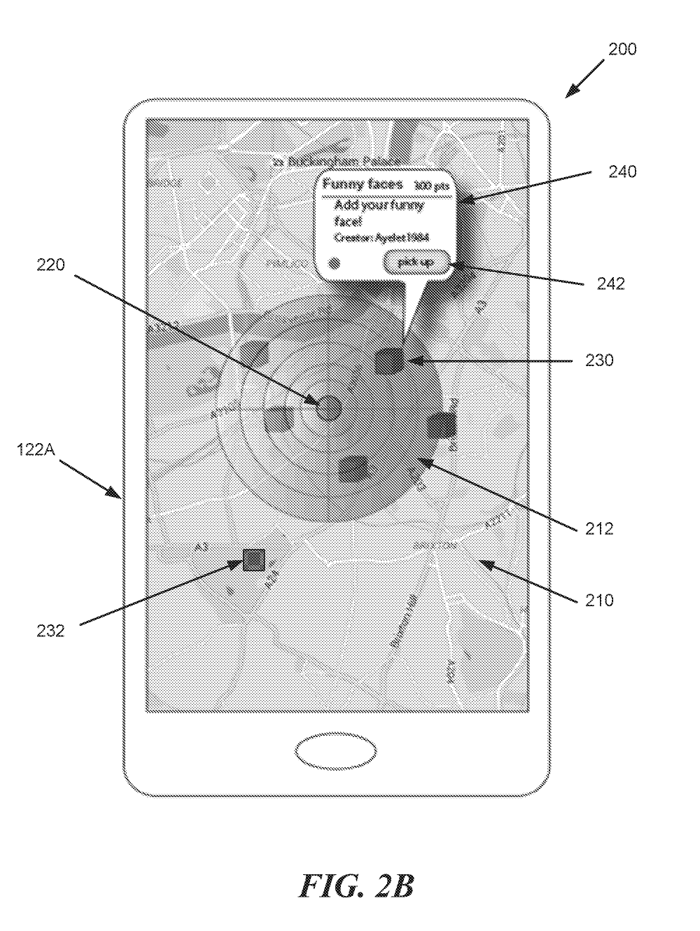

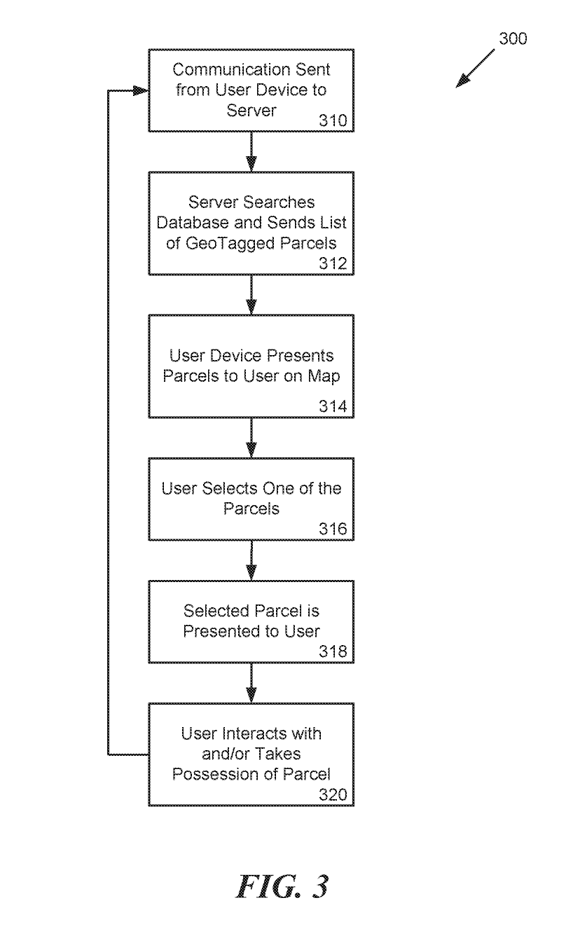

In operation, each user creates an account that can be associated with a user device and installs one or more software modules on the user device that enables the user to log into the virtual reality system and interact with the virtual environment to locate and interact with parcels, and create parcels. After the user logs into the system, a software module on the user device presents the user with a display of the virtual environment, for example, as shown in FIGS. 2A and 2B. The display can include a map of all or a portion of the virtual environment and an identification of the location of the user device on map. The display can also indicate the location of one or more parcels and other real and virtual objects on map of the virtual environment.

In order for the user device to display the map of the virtual environment and the parcels, the user device 122A transmits user information and user device location data to the server 112 and the server 112 searches one or more databases to confirm that user account information is valid and searches one or more databases for virtual environment map information based on the location data. If the user device does not have the map information (e.g., graphic map images and location data) for the provided location information in its local memory, the server sends the map information to the user device. The server also searches one or more parcel databases for parcels within a predefined distance from the provided location information. For example, the server can determine the absolute distance (e.g., in meters or feet) from the user device location to the parcel location and then compare that determined distance to a predefined threshold distance. If the determined distance is less than or equal to the predefined threshold distance, the server can send the parcel information to the user device. In accordance with some embodiments of the invention, the predefined distance value can be stored in the database 114 as an attribute of a user or an attribute of a parcel. As an attribute of a user, the server 112 can use the predefined distance attribute or a view radius attribute to limit the parcel information that the server 112 sends back to the user device. As an attribute of a parcel, the server 112 first determines whether the parcel is within the view radius attribute value of the user and then when it selects a parcel, it further compares the parcel's predefined distance or view radius attribute value to the distance from the user to the parcel and only provides the parcel information to the user device if the distance is less than parcel's view radius attribute value. In accordance with some embodiments of the invention, for each parcel not within the view radius of the user, but with a predefined distance (e.g., the field of view of the display of the user device) the server can send some information about the parcels within the field of view and the software module on user device can display them to the user, but the user cannot interact with them (e.g., select them and be presented with a menu of actions) until the user device moves within the view radius of the parcel.

In accordance with some embodiments of the invention, the server can compare other attributes or conditions of the parcel to the elements of the user information (e.g., user attributes, for example, age, gender, religious or ethnic affiliation, height, shoe size,) in order to determine whether to send the parcel information to the user device. For example, where the parcel is designated for an adult or contains adult content (e.g., a coupon for a free drink at a bar or an adult oriented audio or video clip), the server can compare one or more age restriction attributes of the parcel to the age information of the user account to determine whether the user is over 18 or 21 (e.g., the user age attribute is compared to the age restriction attribute value) and only send the parcel information to the user device if the user account information indicates that the user is over 18 or 21. For each parcel determined to be within the predefined range of the user device, the server can search for the restriction attributes of the parcel and compare each restriction attribute to a corresponding attribute of the user or the user device to determine whether the parcel information should be sent to the user device. For example, where the parcel represents a free copy of an Apple iOS app or a free iTunes™ song or video, the parcel can include a user device restriction attribute that restricts the parcel to user devices that use the Apple iOS operating system or include an iTunes account and the server can compare the user device operating system attribute (e.g., iOS, Android, Windows, Linux, Chrome) to the parcel OS restriction attribute for a match. If the attributes match, the parcel information can be send to the iOS based user device and if they do not match, the parcel information is not sent. The result is that the system can present two users with different user device attributes (e.g., iOS, Android, Linux, Windows) or user attributes (e.g., age, gender, coffee preference, such as Dunkin Donuts vs. Starbucks) with different maps of local parcels even though they are in the same location.

In accordance with some embodiments of the invention, users can choose to be members of a community (e.g, a bookclub, a college or university or organization with the college or university, or a religious or social organization) and each parcel can include one or more community attributes (e.g., a community name and/or community ID) that restrict or enable a user having a matching attribute to see, interact and pick up the parcel. In accordance with some embodiments, the user's account can include one or more community attributes (e.g., mystery-writers-bookclub) and the parcel can have the same attribute, whereby the server 112 can compare the value of the user community attribute (e.g., mystery-writers-bookclub=True) to one or more parcel community attributes (e.g. parcel(mystery-writers-bookclub)=user(mystery-writers-bookclub)) to determine a match that would enable the server 112 to send the matching parcel information to the user device. In accordance with some embodiments of the invention, the user's account and the parcel can include a “community” attribute that can include one or more values (e.g., “mystery-writers-bookclub,” “glee club,” “university club,” etc.) and wherein the server 112 can compare the individual values of the “community” attribute of the user and the parcel to determine a match that would enable the server 112 to send the matching parcel information to the user device.

As shown in FIG. 2A, the user device 122A presents the user with a map 210 and icons representing the locations of parcels 230 in relation to the location 220 of the user device in the map 210 of the virtual and/or real world. The map 210 can also include a range indicator 212 which shows which parcels 230 are within range of the user device location 220. The software module can limit the user's ability to interact with parcels 230 that within range 212. For example, the user cannot interact with parcel 232 because it is not within range of the user device location 220 and is shown to enable the user to move within range of the parcel 232 to enable the user to interact with it. The user can select one of the parcels 230, as shown in FIG. 2B and a parcel information menu 240 displaying information about the parcel 230 can be presented to the user. The parcel menu 240 can include one or more user interface elements 242 (e.g., buttons or highlighted text or images) that enable the user to interact with the parcel 240. Using the user interface (e.g., touch or a mouse pointer) the user can select the parcel menu 240 or portions of the parcel menu 240 (e.g., a “?” icon) to cause the user device to display information about the parcel, preview parcel content or chat with a user associated with the parcel (e.g., a former possessor or the owner). For example, as shown in FIG. 2B, the selected parcel 230 can include a “pick-up” button 242 which enables the user to take possession of the parcel 230. When the user takes possession of the parcel 230, the user device 122A sends data to the server 112 indicating that the user took possession of the parcel 230, including the identity of the user (e.g., the user ID) and optionally, the date and time that the user took possession. The server 112 can update the database 114 to reflect that the user with the user ID took possession of the parcel (e.g., parcel ID) on the specified date and time. For example, the database 114 can include a unique identifier for each parcel 230 and the possessor field or attribute can be updated to include the user's user ID and/or the parcel ID can be associated with the user's user ID. In addition, the server 112 can update the user's account to include the points or credits that are associated with the parcel 230 (e.g., as shown in FIG. 2B, the Funny Faces parcel earns the user 300 points).

The user can interact with the parcel after taking possession of it. For example, as shown in FIG. 2B, the Funny Faces parcel 230 can provide the user with access to an app, for example, either by downloading the app or through a web page, that enables the user to take a picture of themselves and edit it to make the a funny face and upload the picture to the Funny Faces webpage, or upload the picture to a Funny Faces database that can be viewed using a Funny Faces app. In accordance with some embodiments of the invention, the user can take a picture using the user device 122A and upload the picture taken directly (e.g., to the database 114 or a separate content database) using, for example, the software module to be associated with the parcel 230 so that it can be viewed as a type of parcel 230 associated content.

After the user interacts with a parcel, the user can then drop the parcel to enable another user to interact with and/or take possession of the parcel. The user can select the parcel from a list of parcels in their possession (e.g., the user device software module can display a list of parcels created by, owned by and/or possessed by the user) and be provided with (or select) a menu that provide a list of operations, such as drop the parcel. Selecting the drop parcel operation causes the parcel to be dropped and the user device sends data to the server 112 including the parcel ID, the location where the parcel is dropped and the date and time when the parcel is dropped. The server 112 updates the parcel attributes (e.g., information fields) in the database 114 to indicate that the parcel is available to be picked up, including the location, date and time it became available (e.g., the possession attribute value is set to available or dropped). In accordance with some embodiments of the invention, the user can drop the parcel and the parcel can return to the original location where the user found and/or picked up the parcel (regardless of the location of the user when the parcel is dropped). In accordance with some embodiments of the invention, the user can drop the parcel in a different location from the location where the user picked it. In accordance with some embodiments of the invention, the user device can present the user with a map of the virtual world and the user can select a location within the virtual world to drop the parcel. In accordance with some embodiments of the invention, the user device can use the location of the user device as the drop location for parcel, such that if the user device has been moved to a new location, the parcel will be dropped in a new location.

The user's ability to pick-up and/or drop the parcel and location that the parcel 230 can be dropped can be controlled by attributes associated with the parcel 230 (e.g., stored in the database 114) that are transmitted from the server 112 to the user device 122A when the user device 122A comes within range or when the user selects that parcel 230 on the display screen of the user device 122. The software module being executed on the user device 122A can use the parcel 230 attributes to configure the parcel menu 240. In accordance with some embodiments of the invention, information from one or more of the parcel attributes (e.g., the parcel name, parcel ID, parcel owner, parcel instructions, parcel points, etc.) can be displayed to the user and for example, one or more of the parcel attributes can be used to select or enable the information to be displayed to the user. In accordance with some embodiments of the invention, information from one or more of the parcel attributes can used to select or enable the user interface elements 242 that are presented or active in the parcel menu 240. For example, if a parcel can only be dropped back at its original location, the software module can test one or more drop location attributes of the parcel (e.g., drop location=fixed or drop location=specific coordinates) and configure the parcel menu 240 to disable (e.g., grey out) or not show the user interface element (e.g., drop location button/menu entry) that enables the user to specify the drop location. In accordance with some embodiments of the invention, each time a parcel is dropped or picked up, the user name and/or ID of the user, the location, the date and time can be stored in attributes or data associated with the parcel and, optionally, a historical record of each user that interacted with some or all of the parcels can be stored in the database 114 or a separate historical database.

In addition to picking up or dropping a parcel within range of a user device, the user device through the software module can provide other functions or operations that involve a parcel. These functions and operations can be accessed through menus and/or user interface elements provide by the software module to the user. For example, where the parcel includes associated content, such as text, audio or video, the software module can test one or more of the attributes of the parcel (e.g., content=yes/true and/or content=[link]) and if content is enabled, the software module can provide a menu item or user interface element that enables the associated content to be viewed. The software module can use other apps or software modules on the user device to present content, such as a text viewer (e.g., notepad, or Adobe pdfviewer), or an audio and/or videoplayer (e.g., Google Android Music or Video Player, or Apple iTunes). The software module can obtain access to the content by sending an access request to the server 112, which can stream or download the content from the database 114 or a content server to the user device. The server 112 can receive the access request and lookup in the database 114 the location of the content and then send a communication to a content server to stream or download the content to the user device.

The software app can provide other functionality, including the ability of the user or user device to share the parcel on social media or by email. For example, the software module can interface (e.g., such as by using an API or a shared token representing the parcel to be shared) with social media applications or emails applications to share parcels. In accordance with some embodiments, the server 112 can provide the software app with a token or digital certificate that the software app or the user can include in a social media app or social media interface or on a web page that enables a user to access and take possession of the parcel. In accordance with some embodiments, the token or digital certificate can only be redeemed by one user. When the new user selects or redeems the token or digital certificate from their user device, the user device sends data to the server including the token or digital certificate along with the new user information (e.g., user ID, location, data and time of possession), the server updates the database with the new user information.

In accordance with some embodiments, the token or digital certificate can be redeemed by more than one user, for example, by a predefined number of users or an unlimited number of users (and some tokens or digital certificates can be redeemed by the same user more than once). The database 114 can include an attribute associated with the parcel (e.g., the parcel ID) that indicates the number of times the token or digital certificate can be redeemed. Each time the token or digital certificate is redeemed, the server 112 can decrement the attribute field associated with the original parcel until the redeem limit field contains zero at which point the token or digital certificate can no longer be redeemed. Thus, for example, an original parcel having a parcel ID in the database can have a share attribute that is a Boolean value (e.g., true=can be shared or false=cannot be shared) and a redeem attribute (e.g., initially set to N) that enables the parcel to be shared with N users. When the possessor of the original parcel sends data to the server requesting to share the parcel, the server can compute a sharing token or digital certificate (or retrieve from the database a previously determined sharing token or digital certificate) and send it back to the user device. When the token or digital certificate is redeemed, the token or digital certificate can be used as a key to a database table or hash table to lookup the parcel ID. After obtaining the parcel ID, the server can check the share attribute or the redeem attribute to determine whether the parcel can be shared, for example, the share attribute associated with the parcel ID is true or the redeem attribute associated with the parcel ID is greater than zero. If the parcel is able to be shared, for example, the server can create a clone of the parcel by creating a database entry for a new parcel having its own unique parcel ID and having an attribute, such as a relation attribute, that points to the parcel ID of the original parcel. The original parcel can include a relation attribute that points to itself (e.g., includes the same parcel ID) or is empty (e.g., zero or null). In accordance with some embodiments, the token or digital certificate can include the parcel ID or include a hash of the parcel ID.

It should be noted that the new or cloned parcels can have some attributes that are different from the parent or original parcel and can have different attribute values than the parent or original parcel. For example, the cloned parcels can expire or disappear after a predefined period of time (e.g., an expiration time attribute) or after an expiration date (e.g., an expiration date attribute). In accordance with some embodiments, the cloned parcels can include a transfer attribute (e.g., true=transferrable and false=non-transferable) that indicates whether the parcel can be transferred to another user and/or a drop attribute (e.g., true=can be dropped and false=cannot be dropped) which indicates whether the parcel can be dropped. These attributes can be sent by the server to the user device and the software module on the user device can use these attributes to determine which menu entries or user interface elements can be presented to the user to control (e.g., enable or disable menu features and parcel functionality). For example, where the transfer attribute is false (e.g., the parcel is not transferrable) the software module can test the attribute value and remove the transfer menu entry or user interface element from parcel menu or screen or the menu entry or user interface element can be shown but inactive (e.g., unselectable or “greyed out”).

In accordance with some embodiments of the invention, a parcel can represent any physical, intangible or virtual object. Thus, a parcel can include an automobile, a book, or a song (or all of them) and can also include a ride in the automobile, a read through (or period of time in which to read) the book, and/or one or more listens to the song. In accordance with some embodiments of the invention, each parcel can include many attributes which define what the parcel is as well as the properties or attributes of a parcel and the users' rights with respect to the parcel and how those rights can be changed. In accordance with some embodiments, a parcel can have an owner, and in addition, can have one or more possessors or users who are separate and distinct from the owner and the owners and possessors can change over time. In accordance with some embodiments, the possessor can also be the owner during their time of possession. Alternatively, the owner can be separate from the possessor or user and the owner control some or all of the attributes of the parcel throughout its existence, while the possessor can have limited or no ability to change the attributes of a parcel in their possession.

In accordance with some embodiments, when a parcel is created or initialized, it can include a type definition or object attribute (e.g., physical, intangible or virtual), an owner attribute, a possessor attribute, and a set of state and transfer properties or attributes. These attributes or properties can be reflected in data values in attribute fields of the database 114 that are associated with a parcel or parcel ID. The attribute data values can be Boolean values (e.g., true or false, yes or no, or 1 or 0) or the data values can be text strings that indicate the attribute state (e.g., a motility attribute can contain “moving,” “stationary,” “flying,” “moving on a train”) or numeric values (e.g., limits—can be shared 10 times, or expiration date). The state attributes can indicate the state of the parcel, such as its location, which can include its possession state (e.g., dropped and unpossessed or waiting to be found and possessed) or moving state (e.g., not moving, traveling in a motor vehicle or carried by a user, or moving in a virtual world, or traveling through time). Some attributes can be used by the server 112 as conditions that can be related to other attributes. For example, a transfer condition attribute can restrict the transfer of ownership or possession to a recipient user that meets certain conditions (e.g., the transfer of a parcel can be restricted to recipient users from the same community, organization or family). In accordance with some embodiments, one attribute can include a pointer or reference to one or more condition attributes can include two or more values. For example, an attribute (e.g., owner attribute) can include an owner value (e.g., the name or user ID of the owner) and a pointer to one or more condition attributes (e.g., a “transferrable” attribute indicating whether the ownership can be transferred and conditions under which the parcel can be transferred, such as, the recipient user company attribute value matches the company attribute value of the current possessor). A condition attribute can include at least two values, for example: 1) a value indicating the attribute to be evaluated, 2) the threshold value to be compared to value of the attribute to be evaluated, and optionally 3) a pointer or reference to another condition attribute to be evaluated (e.g., in addition to being part of the same company, the recipient may need to be part of the same division within the company (e.g., the value of the division attribute of the recipient is the same as the division attribute value of the current possessor). In accordance with some embodiments, the threshold value of a condition attribute can be a pointer to the value contained in another field in the database. For example, the first value (of the condition attribute) refers to a company division attribute, and the second value (of the condition attribute) can point to the company division attribute of the current possessor or owner of the parcel. In operation, the software module looks at the first value to identify the attribute of the recipient (e.g., the user that the parcel is being transferred to) to be tested (e.g., their company division attribute values) and uses the second attribute (e.g., the company division name of the current owner) as the threshold or test value (e.g, does the company division of the recipient equal the company division of the current owner?).

Other possession attributes can include how a user comes to possess the parcel (e.g., obtains the ability to take possession of the parcel) such as by walking or riding into, through or over the location of the parcel and/or performing a physical act (e.g., stopping on or near the parcel, move, position and/or rotate the user device in a predefined way, shake the user device, jumping, running, perform a series of steps, etc.) or touching a representation of the parcel on the screen of a user device (e.g., a smart phone, table or other portable electronic device). For example, one condition attribute of the possession attribute can include that a motility state attribute (e.g., a defined state or speed of motion) of the user device indicates that the user device is stopped (e.g., the attribute value=stopped or is less than X miles per hour) and the distance to the parcel (e.g., the distance between the user device location attribute and the parcel location attribute) being within a certain threshold distance (e.g., threshold distance is less than or equal to x feet, the threshold distance attribute value), such that when the user device sends a request to the server for parcels within range, the server 112 can identify a parcel within range and test the possession attribute to identify possession conditions. The server 112 can test the first condition (that the user is stopped) by comparing a motility attribute value to a threshold (e.g., does the motility attribute value=stopped or is it less than 1.0 miles per hour) and compare the calculated distance from the user device location to the parcel location (e.g., is the user device less than x feet from the parcel). If these conditions are met, then the server 112 can send the parcel information to the user device. In addition, the server 112 can send the possession condition attributes to the user device, the software module in user device can evaluate the conditions after the parcel information is received and either decline to display the parcel on the map display of the user device or disable the possession menu entry (e.g., the pick-up button or take menu entry) if the user device begins moving or moves beyond the threshold distance (e.g., the threshold distance attribute value) to take possession of the parcel. The software module in the user device can detect movements of the user device using a sensor (e.g., an accelerometer, gyro, and/or GPS) in the user device to detect movements of the user and/or the user device (e.g., movements of the user and/or the user device to maneuver the user device in a predefined way, such as traversing a maze or simulating the rotational movements of a combination lock) that can be compared to predefined movement signal data that enable the user to pick-up the parcel (e.g., the software module determines that some or all the of the sensor signal data matches or is within a predefined tolerance of the predefined movement data. If the sensor signal data does not sufficiently match, the user can be given a configurable number of attempts to accurately complete the movements before being informed that the parcel cannot be picked up or that the user will have to wait a predefined period of time before trying again.

Other attributes can include the ability to modify, add or delete the attributes of the parcel. In accordance with some embodiments of the invention, the user or owner may need to purchase the ability to modify, add or delete attributes. Purchase in this context includes through the payment of money (e.g., legal tender) as well as virtual currency and/or points or credits that users and owners can accrue by successfully completing accomplishments in the real world or a virtual world.

In accordance with some embodiments, a parcel can be related to a statue, a building or other physical object or a virtual statue or object that does not move (e.g., it remains in a fixed location). The stationary parcel can include specific attributes that enable the owner, user or processor to change the stationary parcel or permit others to access it.

The owner or possessor of the stationary object can, for example, change its color or other aspects of its appearance, either actually, (e.g., make the stationary object a specific color or color pattern by controlling real lights that illuminate the object) or virtually, (e.g., make the statue appear to be a specific color or color pattern when viewed on the screen of the user device by any user, e.g., with using the user device). In accordance, the owner or possessor of a stationary object can control access to the object by specifying attributes of the parcel associated with the object that enable or disable features of other users with respect to that parcel. For example, an owner can make the parcel associated with an object (e.g. a statue or building) invisible to users having specific attributes (e.g., the attributes associated with a user ID equal or exceed some threshold value), such that a member of one community (e.g., Yankees Fans) would not see specific parcels in and around Fenway Park (e.g., visible to Redsox Fans or Mets Fans). This can be accomplished using the user device to display an image (e.g., either live or not) of the object (e.g. a statue or a building) with parcel content overlaid on the image so it is only visible to the user.

In accordance with some embodiments of the invention, the user or possessor can tag an object with a virtual message (e.g., a tag or message parcel) that can be viewed on the screen of some or all user devices. The message can be restricted using conditional attributes to a specific user or a set of users, for example, to a friend, family members, or members of a community, a company or a division of a company. Thus, one user can post a message parcel at a restaurant for colleague that they are meeting for dinner that they are running late or that the wait is too long at the first restaurant and that obtained a dinner reservation at a second restaurant up the street. The colleague can search for parcels by location (e.g, viewed on a map or by inputting a location, such as an address or GPS coordinates to a search box) or by user (e.g., by inputting the user name or user ID or parcel name or parcel ID into a search box), can read them without needing to be in the location of the original restaurant. The user device software module can include a search module that uses the search information from the search box to send a search request to the server 112 to search the parcel database for parcels matching the search information and send matching parcel information back to the user device to be displayed to the user. In accordance with some embodiments, a parcel can be associated with a messaging service (e.g., an email service or text messaging service) that also sends a copy of the message or a link to the message by email or text using a messaging app or an API to a messaging app.

In accordance with some embodiments of the invention, the message or tag parcel can include a critique or review of a business that can be viewed by everyone or restricted to members of an organization or group (e.g., a subscription service, such as a restaurant review service or magazine subscription). For example, where the object is a restaurant or a location is adjacent a restaurant, the tag or message parcel can include a review of the restaurant, its service, and/or specific dishes served or where object is a hotel, the tag can include a review of the hotel, its rooms, amenities and/or its services. In accordance with some embodiments of the invention, tag or message parcel can include one or more text content attributes as well as picture and/or video content attributes that either store the content directly (e.g., as a binary large object) or contain a link or pointer to access the content from a data server or a content server. The tag or message parcel can also include date and/or time attributes about when the review was given as well as an identifier associated with the user that dropped (e.g., posted the tag or message parcel) and any conditional attributes the can also be provided. These attributes can be stored in the database 114 and associated with the parcel.

The server (114) or a remote client or server can periodically access the server to search the database for stale parcels (e.g., parcels that have not been used or accessed in a predefined period). In accordance with some embodiments of the invention, each parcel can include a touch attribute that gets updated with the current date every time a user picks up the parcel or otherwise interacts with the parcel according to one or more predefined conditions or rules. The server, remote client or server can periodically search the database for parcels having a touch attribute value older than a predefined date and either delete the parcel (e.g., delete the parcel record and all its attribute fields from the database) from the database or move the parcel to an archival database. This enables old tag and message parcels to be deleted. In accordance with some embodiments, some or all of the parcels in the database can include an expiration date and the server, remote client or server can also search for expired parcels (e.g., parcels have an expiration date before the present date) and delete or archive the parcel record.

In accordance with some embodiments, a parcel can include a moving state that provides for virtual time travel. For example, a user or owner can enable a parcel to be present at a specific location at a specific time in the future or the past, thus enabling a new user or possessor to take possession of the parcel when they pass through the specified location (or within a predefined distance to the specified location) at the specified time in the future or the past. Thus, the parcel can include a time travel motion attribute that includes a location and a an active time (or time range) and the system can be configured to identify the closest user to the specified location at the specified time in the future or the past and transfer possession of the parcel to that user. In accordance with some embodiments of the invention, when the user device sends its location data to the server requesting parcels within range, the within range definition can also include an active time attribute that specifies a date and/or time after which the parcel is active. Thus, the database can search for parcels within a predefined physical distance from the user device and that have become active (e.g., the active date is less than or equal to the present date) and only send information about those parcels to the user device.

In accordance with some embodiments of the invention, a user or owner can enable a parcel to be present at a specific location at a specific time in the past, thus enabling a new user or possessor to take possession of the parcel if they passed through the specified location at the specified time in the past. This can be accomplished by including a historical database of the users and the locations of those users in the past and then searching the database to identify the user (or users) that was/were closest to (or within a predefined distance to) the specified location at the specified date or time in the past (e.g., based on an active time attribute date or time or date/time range) and transferring possession to that user. In accordance with some embodiments of the invention, the historical database can store information about location and time of each user as a set of discrete points (e.g., database elements) or as a set of vectors (e.g., a starting point and a direction) and this information can be used store the past location information of a user. In accordance with some embodiments, once the time travel into the past is set by specifying the time and place location attributes of the parcel (in the past), the parcel is either transferred instantly because a user passed through or was within a predefined distance to the specified location or will not be transferred because no user is found in the database. In accordance with some embodiments of the invention, prior to the time traveling parcel being transferred to the user, the server can send data relating to the parcel to the user device and the software module can prompt the user with message (e.g., via a pop-up message, an email, text message or other communication) notifying the user that the time traveling parcel is available and give them the ability to interact act with it. The user can take possession of the parcel and user device can send data to the server and the server can update the parcel attributes in the database that the user has taken possession of the parcel. The date and time of possession can either be set to the date in the past or the present date. If the user declines to take possession, the server can search the historical database for the next available user (e.g., the next user device that was within range of the parcel's location after the current user device.) and send the time traveling parcel information to the next user device. Where more than one user device is within range of the parcel at the same time or with the same predefined period of time, the server can send the time traveling parcel information to both user devices and the first user to take possession of the time traveling parcel will be assigned to the possession attribute of the parcel in the database.

In accordance with some embodiments of the invention, the ability to travel in time and transfer possession can be enabled in the future, enabling the creation of virtual paradoxes. For example, a possessor or owner of a parcel can specify in the future (e.g., at a predefined date/time in the future specified by a future travel attribute value, such as one year from the current time) for the parcel to travel back in time to the date/time specified by the active attribute date and be relocated to the specified location (e.g., specified by a time travel location attribute) where the parcel or one or more of its attributes can be changed. For example, the possession of the parcel can be transferred to a new user at a specified time (in the past) if the historical database shows that that the new user was in the location at or around the specified time in the past. The effect of this could be to erase from the history of possession (or create a paradox) in the database of any user that possessed the parcel in between.

In accordance with some embodiments of the invention, one or more attributes of a parcel can be programmed in advance to change in the future. For example, the owner of a parcel can attach a time delayed possession attribute to a parcel that provides for passing possession of the parcel to a different user in the future, thus enabling a past user to re-obtain possession of the parcel in the future by being at the specified location at the specified time.

In accordance with some embodiments of the invention, one or more separate servers can be used to manage time travel attributes and/or programmable attribute changes. For example, a time travel server can query the database for parcels that include active time travel attributes, such as dates in the future which cause one or more changes in parcel attributes, and maintain a sorted list in chronological order and process the programmed attribute changes as time passes into the future. Similarly for past time travel, one or more separate servers can process parcels that have time travel attributes relating to dates in the past and access the historical user database to process parcels with respect to the historical database.

Other attributes of a parcel can include an expiration date, such that the ability to possess the parcel or obtain a benefit of the parcel (e.g., listen to a song, see a movie, get a free cup of coffee or an Uber ride) can become blocked. In accordance with some embodiments, where the content or benefit is provided through the software module on the user device, when the user attempts to obtain the benefit of a parcel by selecting a parcel or an operation associated with a parcel, the software module can compare the present date with the expiration date and display a message to the user that the parcel (or the benefit associated with the parcel) has expired. In accordance with some embodiments, once the expiration date and/or time of a parcel has passed, it can no longer be used and its benefit can no longer be obtained. In accordance with some embodiments, after the expiration date and/or time of a parcel has passed, the user or possessor (or a third party) can perform an act (e.g., such as transfer currency or points) to extend or remove the expiration date and/or time to enable the benefit to be obtained. One of the attributes of the parcel or its expiration date can include the act or amount of currency or points needed to extend or remove the expiration date and/or time.

In accordance with some embodiments of the invention, a parcel can represent an interested in a real object, such as a deed to property (both tangible and intangible) or purchase receipt evidencing ownership of a physical object. For each parcel, the database can include an identification of a user ID attribute, a date of purchase attribute, a purchase amount attribute, a seller attribute and other information or even a copy or link to a copy of a document such as a deed of sale or receipt of purchase or a block chain transaction identifier. Each time the parcel changes hands and is transferred from one user to another, a transfer record including the identification of a user ID attribute, the date of purchase attribute, the purchase amount attribute, the seller attribute (e.g., the prior user ID) and other information or even a copy or link to a copy of a document such as a deed of sale or receipt of purchase can be added to the database. The database can serve as an electronic registry that maintains the history (e.g., chain of title) of the property or physical object. In accordance with some embodiments of the invention, the parcel can include the deed to a house or a license to copy of song.

In accordance with some embodiments of the invention, the software module (or the parcel system website) can enable the user to create a user account which associates the user (e.g., user account information such as email address and password) with a user ID. While the user ID can be unique to each user, in some embodiments of the invention, more than one user can be associated with a user ID. When a user account and user ID are created, the software module can prompt the user for additional information that can be used define additional attributes of the user. In accordance with some embodiments, each user can be assigned a view radius attribute that is used by the server 112 to determine which parcels are within range of the user device 122A. When the user ID is initially created, the user's view radius can be set to a default value (e.g., 10 meters). When the software module on the user device 122A connects to the server 112, it provides the coordinates of its location and the server 112 looks up the user ID in the database 114 and uses the view radius attribute value to determine which parcels are within range, by comparing the distance between the user device and the parcel location in the database. The server 112 then sends a list of parcels that are within the view radius to the user device 122A. Each time a user picks up a parcel or otherwise interacts with a parcel or the parcel system, the user account can be awarded points. As the user accumulates points (e.g., stored in a points attribute in the database 114 associated with a user ID), the server 112 can change (increase or decrease) the value of the view radius associated with the user's user ID in the database as a function of the user's accumulated point value. For example, for every 500 points accumulated, the user's view radius can increase by 5 meters. In accordance with some embodiments of the invention, the each user account (e.g., user ID) can be associated with more than one point system. Some point systems can represent real or virtual money or currency held on account for the user or the user ID. The users can use the points or money gain access to features within the system. For example, the user can select an option within the software module (or the parcel system website) that enables the user can redeem points to increase their view radius. The software module can prompt the user to input the amount of the increase (e.g., 5 meters) and send a request to the server 112 to increase the user's view radius. The server 112 can compare the fee (e.g., 500 points to increase 5 meters) to total points value in the user account and if the user has sufficient point, deduct the points and increase the user's view radius value in the database 114, and return a message to the user device that the view radius was increased. If the user does not have sufficient points (e.g., user's points are less than 500), the server can return a message to the user device that the user has insufficient points.

In accordance with some embodiments of the invention, the software module can include a user interface element or menu item that enables a user to create a parcel and later edit the parcel. In accordance with some embodiments of the invention, each parcel can include a parcel name (e.g., stored in a parcel name attribute in the database 114) and a parcel ID (e.g., stored in a parcel ID attribute in the database 114). When the user creates a parcel, the user device prompts the user for a parcel name (and optionally, notifies that the parcel is not unique and how many active parcels with the same name exist in the system) and sends a create message to the server 112 causing the server 112 to register a new parcel and assign a unique parcel ID. As part of the parcel creation process, the server 112 initializes a predefined default set of parcel attributes (e.g., parcel type, parcel location, parcel creator name and/or ID, owner name or ID, occasion or reason created, birthdate—date of creation, etc.). The software module (and optionally, through interaction with the server 112) prompts the user for information that can be used to define additional attributes of the parcel. Depending on the attributes defined, the owner (e.g., the original owner or a subsequent) owner can use the software module (and, optionally the server 112) to update and/or edit the attribute values or add attributes to the parcel and the server 112 can log in the database 114, the edit events, for example, using a edit event attribute number, an added content attribute, an added content type attribute, content editor to store a user name and/or ID and any other information that records the changes to the parcel data stored in the database. To edit a parcel, the user device can display one or more groups of editable fields (e.g., text boxes, drop down menus, menus, etch) containing attribute values that enable the user to change and then select a user interface element to save or cancel the changes. In accordance with some embodiments of the invention, when the user creates a parcel, points can be deducted from the points attribute associated with the user ID. In accordance with some embodiments of the invention, the parcel can have one or more attributes that indicate whether the parcel can be edited and who can edit it (e.g., the owner, the possessor, anyone). In accordance with some embodiments of the invention, the parcel have one or more attributes that indicate whether a user can associate a comment (e.g., text, emoji, a like or thumbs-up, dislike or thumbs-down, +1, etc) to the parcel and include one or more content attributes the store the comments (e.g., text attributes, emoji attributes, like attributes, dislike attributes, +1 attributes). The comments can be input directly using the software module on the user device or can be input by interfacing with a social media application such as Facebook, Google+, Twitter. Where the attributes of a parcel indicate that the parcel cannot be edited and cannot be tagged with a comment; the parcel can only be viewed, and in some embodiments, each time the parcel is viewed the user device can send a view event (e.g., identification of what content was viewed, the date and/or time of the view event, and user name and/or ID of the user that viewed the content).

In addition, a user can also log into a website (e.g., the parcel system website) that enables the user to create and/or edit parcels without using the software module on the user device. In addition, other software applications (e.g., social media applications like Facebook, Twitter, and LinkedIn) can also enable a user to create or update a parcel using an API (Application Programming Interface) that communicates with the server 112 or the parcel system website over a network (e.g., the Internet) to enable the user third party software applications to provide the create or update parcel functionality. The website can, for example, enable a user to create a batch of parcels (e.g., including coupons, URLs, bar codes, or QR codes) that the user can distribute over all or a portion of the virtual reality space. The coupon, URL, bar code and/or QR code can enable a user that picks up the parcel to use the coupon, URL, bar code or QR code at an online or real store to redeem them for purchases and/or discounts on products and/or services. The user can select the coupon, URL, barcode or QR code and a software module can process them by opening a website that enables the user to initiate purchases or obtain physical or electronic coupons for products and/or services from one or more vendors associated with the original owner of the parcel. When the parcels are created, they can include a unique code that is stored in the database and incorporated into the coupon, URL, bar code or QR code and to redeem the parcel, the unique code from the parcel can be compared to the codes in the database for a match. If the codes match, the parcel can be redeemed and the unique code can be deleted (or designated as redeemed). The codes do not match the parcel can be denied. The system can also track addition data (e.g., stored as attributes) that indicate the date the parcel was created, where it was dropped, the date it was picked up and the date it was redeemed, and user information of the user that picked up the parcel and/or redeemed the parcel (e.g., the user that picked up the parcel can give it to another user to redeem). This information can be used to compile system information to determine the effectiveness of the coupons by filtering and sorting this information.

In accordance with some embodiments of the invention, a parcel can be used to transfer a payment between users. When a parcel is created, the parcel can include a value or amount attribute and/or an attribute that includes a secure link (e.g., that can include an account, payment or transaction ID) that enables the receiver of the parcel to redeem the payment through the system servers 112. In accordance with some embodiments of the invention, the payment parcel can include a separate payer attribute that is different from the parcel creator attribute and/or the parcel owner attribute. The server 112 can redeem the payment for the user by sending the account, payment or transaction ID or accessing the secure link on a payment processor site (e.g., PayPal, Credit Card processor, Bank) to complete the transaction (e.g., electronically transfer money from the parcel creator's account to the parcel receiver's account) and send a transaction ID and status attribute values to the server 112 to be sent to the user device to confirm that the transaction was completed. In accordance with some embodiments of the invention, the payer (e.g., the paying user) can specify the recipient (e.g., the receiving user name and/or ID) as the owner of the “payment” parcel when the parcel is created or later edited, such that the “payment” parcel appears in the recipient user's list (e.g., “my parcels”). In accordance with some embodiments, any parcel can be transferred from one user to another user, using this method.

In accordance with some embodiments of the invention, some parcels can be edited, enabling users to add comments and/or content (e.g., by providing comments attributes that include date, time, comments, content and name or user ID of the commenter, like commenting on a Facebook post). In accordance with some embodiments of the invention, some parcels cannot be edited, but the system can include one or more attributes that record the number and/or user name or ID of each user that viewed the comments or content of the parcel.

In accordance with some embodiments of the invention, some parcels can include an autonomous mobility attribute that causes the parcel to appear to move after it is dropped. The motion can be provided by the server 112 that includes a software module that changes the location of the parcel with time according to one or more trajectory (e.g., speed, direction, motion method) attributes in the database 114. For example, based on the speed and direction, the software module can periodically update the location of the parcel based on the time that has lapsed, the speed attribute and the direction attribute. The motion method attribute can be used to indicate whether the motion is periodic (e.g., a predetermined time period value) or random. The server 112 can send information about this parcel to the user device and the user device can display the parcel as moving across the map or field of view on the display of the user device. The user can interact with the moving parcel the same way as stationary parcels as long as the parcel is within range (e.g., and the user can follow the path of the parcel to remain in range). In accordance with some embodiments of the invention, the speed and direction attributes can be randomly changed (e.g., a random mobility attribute can be set to true and the server 112 can use a random number generator to generate the distance and direction values of some or all of the next locations. In accordance with some embodiments of the invention, the mobility attribute can include a configurable final destination, such that the parcel location does not change after the location reaches a predefined destination (or within a predefined distance from a predefined destination).

In accordance with some embodiments of the invention, some parcels can include a tracking attribute that causes the server 112 to store one or more locations of the parcel in a tracking database (e.g., the parcel database 114 or a separate database) when the parcel is in the possession of a user (e.g., a user belonging to a predefined community). Once a user that has an attribute that matches the predefined community picks up the parcel, the software module on the user device continuously or periodically sends its location data to the server 112 or a separate tracking server that stores the location data. This information can be shared with other members of the community (e.g., a website can use the location data to provide a map that tracks the location of one or more of the users that are members of the community who have picked up a tracking parcel.

Within the system, communities can be created to restrict access to parcels to members of the community. When a parcel is created (or later edited) a community attribute value (and optionally a description) can be assigned to the parcel. The parcel can be dropped at a location (e.g., assigned a drop location value) in the database. The server 112 can include a list of users that are members of the community. When a user device approaches and becomes within range of a community parcel, the server 112 can compare the user ID or user name of the user device to the list of member of the community. If the user name or ID matches, the server can send the parcel information to the user device for display to the user. If the user is not a member of the community, the parcel will not be displayed to the user. A community can be any set of users and can be defined by one or more users. For example, a community can be a set of people that belong to a book club, a car club, a religious organization, a school, a company, a division of a company, members of a neighborhood, and/or a random group of people that device to be members of a community.

In accordance with some embodiments of the invention, a parcel, when created or later edited, can include user information (e.g., including user attribute information) about the user that created the parcel or a user that later came to possess the parcel. For example, a parcel containing user information can serve as a message (e.g., by specifying one or more owner/possessor attributes), a resume, an invitation (e.g., by specifying one or more owner/possessor attributes and/or community attributes) or a survey.

In accordance with some embodiments of the invention, a parcel can include one or more category attributes that can be used by the user (or user device) and/or the server to filter the parcels that are presented to the user on the user device. For example, parcel category attributes can include personal content, commercial advertising, text, video, news, history, local, national, worldwide, politics, etc. In accordance with some embodiments, the user can configure the user device to limit or filter the parcels presented to the user by selecting one or more categories and sending the category attribute(s) to the server 112. When the server 112 searches for parcels in range of the user also tests the parcel category attributes and selects the parcels with category attributes that match user selected categories to send to the user device. This enables a user looking for historical information to search for historical information and a user looking for restaurants or dining to only receive parcels related to those categories.

In accordance with some embodiments of the invention, a user can include a visible attribute that enables the user's location to be visible to others in the area. Then the visible attribute is set to true or visible, and the visible range attribute is set to a predefined distance, the server 112 can send the users information (e.g., user name and/or ID, user location, user profile or bio information, a picture, phone number or email address) to other uses in the area when the other user's user device interacts with the server 112 to request parcel information. When a user device receives user information, it can present the visible users on the screen using different icons. For example, where parcels appear as boxes or squares, users can appear as faces, heads, busts or avatars that may or may not indicate the gender or other attributes (e.g., hair color, eye color) of the user. The user, using the software module, can select the user icon on the screen to see a menu which enables the user to see the user information as well as a menu item that enables the user to communicate (e.g., talk, chat or text) with the other user. In accordance with some embodiments of the invention, the software module can use the text, email or phone apps installed on the user device to enable two or more users to communication. In accordance with some embodiments of the invention, a chat/voice parcel can be created that enables two or more users to communicate. When the chat or voice parcel is created, the text of chat or sound of the voice message is the content of the parcel that is captured and sent by the software module to the server 112. The server 112 can optionally store the content in the database 114 or a separate content database, and send the content to the other user(s) user device for playback or viewing.

In accordance with some embodiments, a parcel can include time attribute linked to an action attribute that causes one or more other attributes of the parcel to change at a predefined time or after the expiration of a predefined period time (e.g., from one or more time attribute values). For example, at the time (and date) designated by the time attribute, the dropped attribute of the parcel can be changed by the server 112 (or a separate server) to indicate that the parcel is dropped and the owner or possessor attribute can be changed to unknown or open. This can cause the parcel to be dropped at a predefined time. The action attribute can also specify a predefined location where the parcel is dropped (e.g., at the location where it was picked up) or use the current location of the current user/possessor/owner.

As a general matter, each user can only view the parcels they own or have in their possession as well as those parcels that are in range. In accordance with some embodiments of the invention, a parcel can include an attribute (e.g., a visibility attribute) that enables the location and the user name or ID of the current owner or possessor to visible to others. The visibility can be limited to other users that are within range of the user or can be visible to a user that does a search by parcel name or parcel ID. Then a parcel has its visibility attribute set to visible, another user can see the parcel on the display of their user device (e.g., the parcel can be a different color or have colored border that makes it look different from other dropped parcels). When a user selects the visible parcel, the software module can provide a menu enabling the user to obtain information about the parcel, the user that owns or is in possession of the parcel as well as can enable the user to communicate (e.g., by phone, text or chat) with the owner or possessor of the parcel.

Some or all of the operations within the system can result in points being added or deducted from the user's account (e.g., the points attribute value being increased or decreased by a predefined amount).

In accordance with some embodiments of the invention, the system can be used to control user access to stationary (e.g., desktop) computer system or a mobile computer system. For example, a user logging into the computer system or a web page on the computer system, select a user interface element (e.g., a login button) to initiate the login process. The computer system can determine its location (e.g., using a positioning system such as GPS, or using IP location services) and send its location to the login server (e.g., server 112). The login server can search for mobile devices within range (e.g., the distance between the location of the computer system and the mobile device is less than a predefined distance) of the computer system. In accordance with some embodiments of the invention, the login server can search a database that stores the user IDs associated with (e.g., logged into) one or more user mobile devices along with the location of each mobile device. In response to the user login attempt, the login server sends a list of user names or user IDs associated with the user mobile devices within range of the computer system and presents the list to the user on the display screen of the computer system. The user can select their user name or user ID from the list which causes the computer system to send the selected user name or user ID to the login server. The login server can send an enable login message to the user mobile device associated with the selected user name or user ID, which can cause a message to be presented to the user (e.g., “Enable user to login on the computer system?”) on the mobile user device and enable the user to select a user interface element confirms or denies the user access to the computer system. The user mobile device can send a message to the login server with the confirmation (or denial). If the message includes a confirmation, the login server can send a message or communication to the computer system, logging the user into the computer system. The confirmation message can include a signed message or encrypted copy of the login credentials (e.g., user login ID and password). If the message includes a denial, the login server can send a message or communication to the computer system that does not enable the user to log into the computer system. In accordance with some embodiments, the communications between the login server and the user device can be encrypted, for example using transport layer security (e.g., TLS, such as SSL).

After the user is logged into the computer system, the user can continue to use the computer system, until either the user logs out, the expiration of a predefined time period or the user moves away (e.g., beyond a predefined distance) from the computer system. In accordance with some embodiments, the computer system and/or the login server can include a timer or a counter that expires after a predefined period of time. In the computer system, the expiration of timer or counter causes the computer system to send a renew login message to the login server and the login server sends an enable login message to the user mobile device, which can cause a message to be presented to the user (e.g., “Continue to enable user login on the computer system?”) on the mobile user device and enable the user to select a user interface element confirms or denies the user access to the computer system. The user mobile device can send a message to the login server with the confirmation (or denial). If the message includes a confirmation, the login server can send a message or communication to the computer system, maintaining the user logged into the computer system. The confirmation message can include a signed message or encrypted copy of the login credentials (e.g., user login ID and password). In the login server, the expiration of timer or counter causes the login server to send an enable login message to the user mobile device, which can cause a message to be presented to the user (e.g., “Continue to enable user login on the computer system?”) on the mobile user device and enable the user to select a user interface element confirms or denies the user access to the computer system. The user mobile device can send a message to the login server with the confirmation (or denial). If the message includes a confirmation, the login server can send a message or communication to the computer system, maintaining the user logged into the computer system. The confirmation message can include a signed message or encrypted copy of the login credentials (e.g., user login ID and password).

In accordance with some embodiments of the invention, the login server can periodically check the location the user's mobile device and if the distance between the user mobile device and the computer system is greater that a predefined distance, the login server can send a message or communication to the computer system that causes the computer system to log the user out of the computer system and, optionally, lock the computer system. To check the location of the user mobile device, the login server can send a message requesting the user mobile device to send its location back to the login server. The login server can compare the distance between the location of the user mobile device to the location of the computer system to a predefined distance and if the user mobile device has moved beyond the predefined distance (e.g., 5 meters, 10 meters, 20 meters) from the computer system, the login server can send a log out message the computer system that causes the computer system to log the user out of the computer system.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

What is claimed is:

1. An interactive system comprising:
at least one database storing data about one or more parcels including a parcel ID and a first attribute containing an identifier of an owner of associated with at least one parcel, and a second attribute containing location information indicating a location of the at least one parcel;
at least one server connected to a network and connected to the at least one database, the at least one server being configured to access the at least one database to retrieve data relating to the one or more parcels from the database and store data relating to the one or more parcels in the at least one database; and
a user device including a network interface adapted to connect the user device to the network and to send data to and receive data from the server relating to parcels.

2. The interactive system according to claim 1 wherein the user device includes a positioning system that produces location information about the location of the user device and the user device is configured to send at least some of the location information indicating the location of the user to the at least one server.

3. The interactive system according to claim 2 wherein the server includes a software module configured to receive the location information from the user device and store the location information in the at least one database; and wherein a software module in the server is configured to search the at least one database for one or more parcels and for each parcel found, a software module in the server is configured to determine a distance between the location of the user and the location of the at least one parcel; and the server is configured to send the second attribute containing the location information of the at least one parcel to the user device.

4. The interactive system according to claim 3 wherein the user device further includes a display screen and wherein the user device receives the second attribute of the at least one parcel and includes a software module configured to display a map including a representation of the user device and a representation of the at least one parcel.

5. The interactive system according to claim 4 wherein a user can select the representation of the at least one parcel on the display screen and the user device includes a software module that configures the user device to display a menu on the display screen and the menu includes a user interface element that when selected causes the user device to send a user ID of the user to the server causing the server to change the first attribute of the at least one parcel to include the user ID of the user.

6. The interactive system according to claim 5 wherein the at least one database includes a points field associated with the user ID and the points field is changed by the server when the server changes the first attribute of the at least one parcel.

7. The interactive system according to claim 1 wherein the at least one database further includes a third attribute associated with the at least one parcel in the database, and the third attribute associated with the at least one parcel includes content and the server includes a software module that is configured to retrieve the content from the at least one database and send the content to the user device and the user device displays the content to the user on the display screen.

8. The interactive system according to claim 7 wherein the content includes text.

9. The interactive system according to claim 7 wherein the content includes an image.

10. The interactive system according to claim 9 wherein the image includes a barcode or a QR code.

11. The interactive system according to claim 9 wherein the image includes an advertisement.

12. The interactive system according to claim 7 wherein the content includes video.

13. The interactive system according to claim 7 wherein the content includes audio.

14. The interactive system according to claim 7 wherein the content includes a coupon relating to a vendor.

15. The interactive system according to claim 7 wherein the content includes uniform resource locator (URL).

16. The interactive system according to claim 15 wherein a software module in the user device displays the URL on the display screen and is configured to launch a browser application that loads the URL when the user selects the URL on the display screen.

17. The interactive system according to claim 2 wherein the at least one database further includes a third attribute associated with the at least one parcel in the database, and the third attribute associated with the at least one parcel includes a condition attribute and the server includes a software module that is configured to compare a value of the condition attribute with one or more attributes associated with the user and only retrieve the second attribute containing the location of the at least one parcel from the at least one database and send the second attribute containing the location of the at least one parcel to the user device if the value of the condition attribute matches one or more of the attributes of the user.

18. The interactive system according to claim 1 wherein the at least one server is connected to the at least one database through the network.

19. The interactive system according to claim 18 wherein the network is the Internet.

20. An interactive system comprising:
a database storing data about one or more parcels including attributes values associated with one or more parcels; for each parcel, the database including a first attribute containing location data including a location associated with the parcel;
a server connected to a network and connected to the database, the server being configured to access the database to retrieve data associated with the one or more parcels from the database and store data associated with the one or more parcels in the database; and
a user device including a network interface adapted to connect the user device to the network, and to send user device location data to the server and receive first attribute data from the server.
